(19) United States
(12) Patent Application Publication
(10) Pub. No.: US 2026/0145636 A1
(43) Pub. Date: May 28, 2026

(54) AIRBAG DEVICE

(71) Applicant: TOYODA GOSEI CO., LTD., Kiyosu-shi (JP)

(72) Inventors: Atsushi KASHIO, Aichi (JP); Ryoichi KATO, Aichi (JP); Ken NITAYAMA, Aichi (JP)

(21) Appl. No.: 19/398,979

(22) Filed: Nov. 24, 2025

(30) Foreign Application Priority Data
Nov. 26, 2024 (JP) 2024-205750

(51) Int. Cl. B60R 21/235; B60R 21/237; B60R 21/261; B60R 21/268

(52) U.S. Cl. CPC B60R 21/235; B60R 21/237; B60R 21/261; B60R 21/268; B60R 2021/23538

(57) ABSTRACT

An airbag device has an airbag which is folded and stored inside a vehicle, and an inflator which discharges an inflation gas to be supplied to the airbag. The airbag includes a gas discharge port that is an opening for discharging the inflation gas inside the airbag to an outside, a first sewn portion which seals the gas discharge port, and a second sewn portion which is provided in a periphery of the first sewn portion. A seam of the first sewn portion is released, due to an external pressure applied to the airbag after full inflation of the airbag, to open the gas discharge port. A seam of the second sewn portion is released as an internal pressure of the airbag increases due to an inflow of the inflation gas during a period until the full inflation after a supply of the inflation gas by the inflator is started.

### CROSS-REFERENCE TO RELATED APPLICATIONS

This application is based on and claims priority under 35 USC 119 from Japanese Patent Application No. 2024-205750 filed on November 26, 2024, the entire content of which is incorporated herein by reference.

### TECHNICAL FIELD

The present disclosure relates to an airbag device that is to be mounted on a vehicle and receives and protects a person such as a pedestrian outside the vehicle with an airbag.

### BACKGROUND ART

In the related art, an airbag device is known in which an airbag is deployed from a vicinity of a rear end of a hood panel during a collision of a vehicle, and a pedestrian or the like outside the vehicle that is about to collide violently with a pillar of the vehicle is received and protected by the airbag, as in a configuration described in JP2007-253923A. The airbag is configured to be stored inside the vehicle in a folded state before inflation is started, to be inflated and deployed when being supplied with inflation gas during the collision of the vehicle or the like, and to be delivered outside the vehicle to cover the pillar of the vehicle at a time of full inflation.

JP2007-253923A discloses a configuration in which a gas discharge port, which is an opening for discharging excess inflation gas inside the airbag to the outside, is provided in the airbag. By providing the gas discharge port in this way, the excess inflation gas is discharged to reduce a reaction force of the airbag, and flipping up of the pedestrian or the like due to the reaction force can be prevented.

JP2007-253923A describes a configuration in which the gas discharge port is opened by cutting a base fabric, that closes the gas discharge port, by an external pressure applied to the airbag when the airbag receives the pedestrian. However, in this configuration, it is necessary to provide the extra base fabric for closing the gas discharge port in the airbag, which may increase a size of the airbag in a folded state and deteriorate a packaging property.

### SUMMARY OF INVENTION

An object of the present disclosure is to provide an airbag device capable of preventing an increase in size of an airbag in a folded state while providing a gas discharge port in the airbag.

An aspect of the present disclosure relates to an airbag device having:

an airbag configured to be folded and stored inside a vehicle, in which the airbag is delivered outside the vehicle while being inflated by being supplied with an inflation gas, and covers at least a part of a front pillar of the vehicle from above at a time of full inflation; and

an inflator configured to discharge the inflation gas to be supplied to the airbag, in which

the airbag includes:

a gas discharge port that is an opening for discharging the inflation gas inside the airbag to an outside;

a first sewn portion which seals the gas discharge port, in which a seam of the first sewn portion is released, due to an external pressure applied to the airbag after the full inflation, to open the gas discharge port; and

a second sewn portion which is provided in a periphery of the first sewn portion, in which a seam of the second sewn portion is released as an internal pressure of the airbag increases due to an inflow of the inflation gas during a period from a time when a supply of the inflation gas by the inflator is started until the time of full inflation of the airbag.

According to the airbag device of the aspect of the present disclosure, an increase in size of the airbag in a folded state can be prevented while providing the gas discharge port in the airbag.

### BRIEF DESCRIPTION OF DRAWINGS

Exemplary embodiment(s) of the present invention will be described in detail based on the following figures, wherein:

FIG. 1 is a schematic plan view of a vehicle equipped with an airbag device;

FIG. 2 is a schematic plan view of the vehicle showing a state where airbags of the airbag device are fully inflated;

FIG. 3 is a schematic cross-sectional view of the vehicle taken along line A1-A1 in FIG. 1;

FIG. 4 is a schematic cross-sectional view of the vehicle taken along line A2-A2 in FIG. 2;

FIG. 5 is a perspective view of a periphery of a gas discharge port of the vehicle with the airbag inflated;

FIG. 6 is a perspective view of the periphery of the gas discharge port of the vehicle with the airbag inflated;

FIG. 7 is a developed view in which the airbag before inflation is deployed flat; and

FIG. 8 is an enlarged view of the periphery of the gas discharge port of the airbag shown in FIG. 7.

### DESCRIPTION OF EMBODIMENTS

Hereinafter, an airbag device 10 according to an embodiment of the present disclosure will be described with reference to the drawings. The dimensions, materials, shapes, and relative arrangements of the components described below are not intended to limit the scope of the present invention to those described below, unless otherwise specified.

The airbag device 10 is mounted on a vehicle 50, and receives and protects a person such as a pedestrian M outside the vehicle 50 with airbags 30, 40. In the following description, unless otherwise specified, a left-right direction means a left direction and a right direction with reference to the vehicle 50, a front-rear direction means a front direction and a rear direction with reference to the vehicle 50, and an upper-lower direction means an upper direction and a lower direction in a vertical direction. That is, the left-right direction means a vehicle width direction of the vehicle 50, and the front-rear direction means a forward direction or a backward direction when the vehicle 50 travels straight.

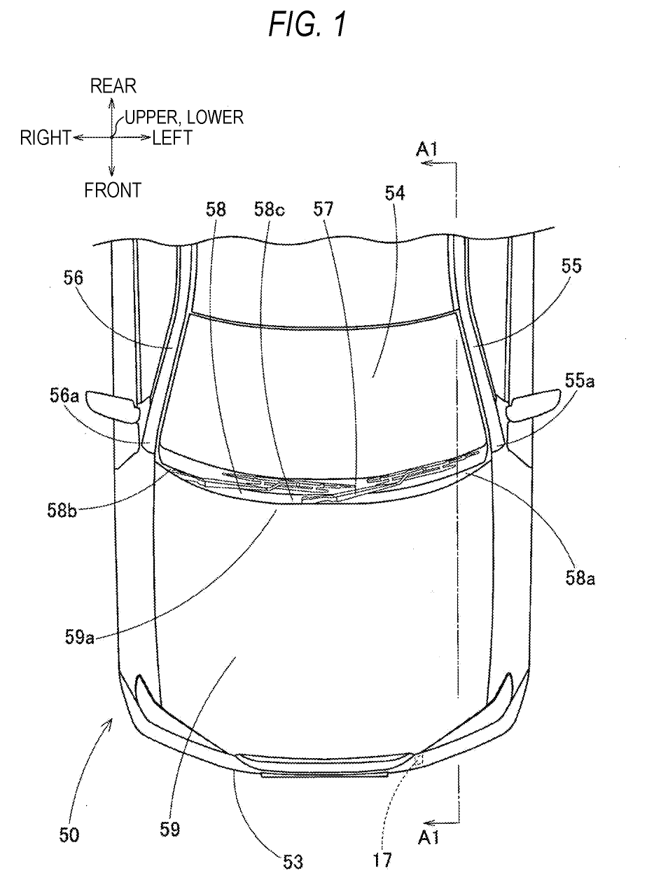

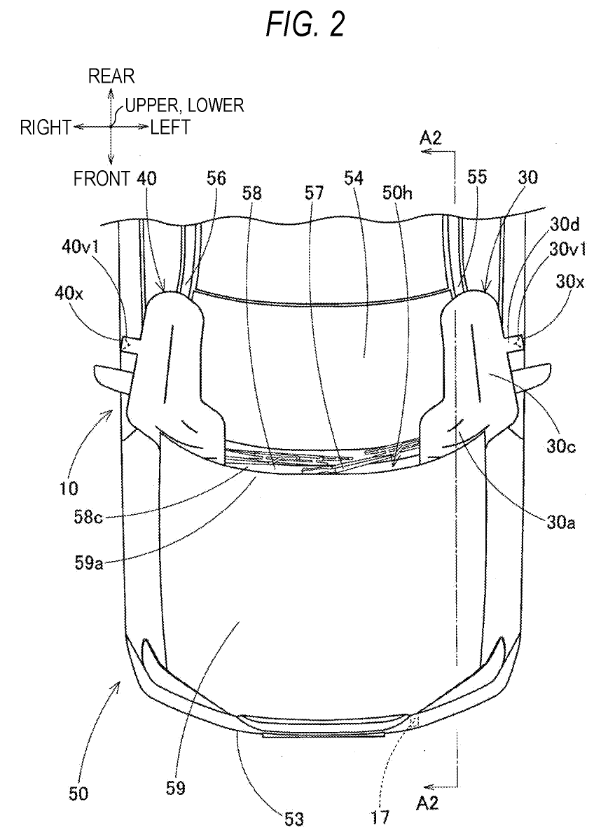

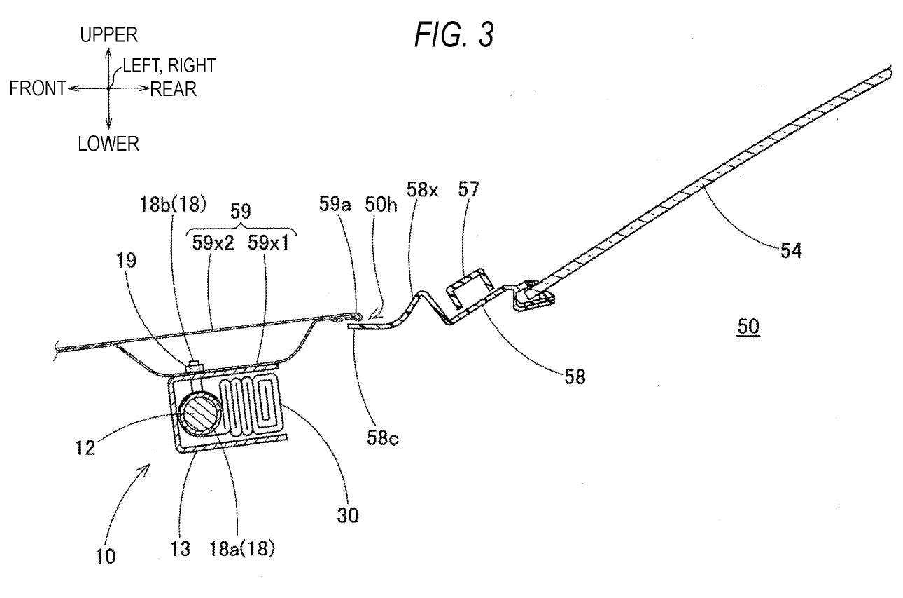

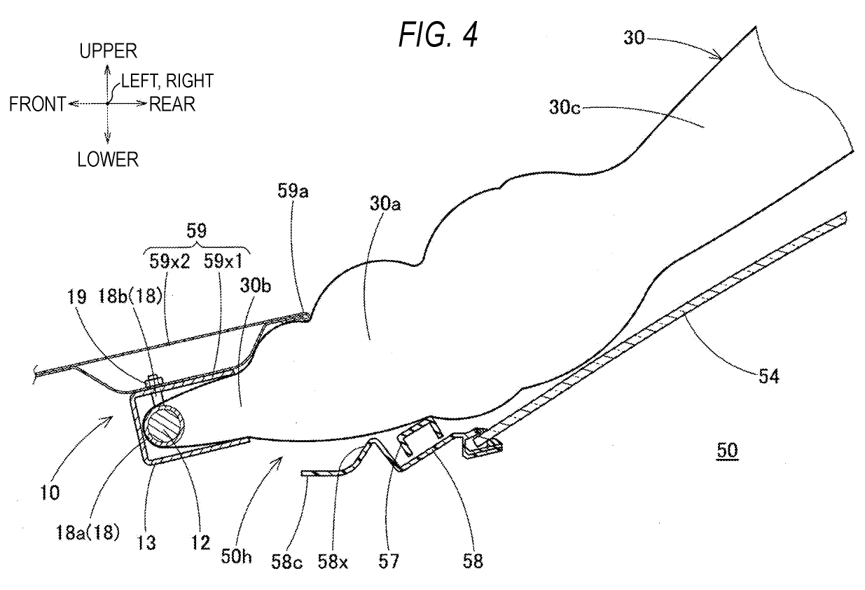

FIG. 1 is a schematic plan view of the vehicle 50 equipped with the airbag device 10. FIG. 2 is a schematic plan view of the vehicle 50 showing a state where the airbags 30, 40 of the airbag device 10 are fully inflated. FIG. 3 is a schematic cross-sectional view of the vehicle 50 taken along line A1-A1 in FIG. 1. FIG. 4 is a schematic cross-sectional view of the vehicle 50 taken along line A2-A2 in FIG. 2.

As shown in FIGS. 1 to 4, the vehicle 50 includes, in a front portion thereof, a front window 54, a hood panel 59 covering an engine room (not shown), and a cowl top panel 58 disposed between the front window 54 and the hood panel 59. Further, the vehicle 50 includes a left front pillar 55 disposed on a left side of the front window 54 and a right front pillar 56 disposed on a right side of the front window 54.

The hood panel 59 includes two panels, including an inner panel 59x1 disposed on a vehicle inner side and an outer panel 59x2 disposed on a vehicle outer side. In a normal state where the airbag device 10 is not operated, a rear end portion 59a of the hood panel 59 is disposed slightly above a front end portion 58c of the cowl top panel 58, thereby a minute gap 50h is provided between the rear end portion 59a of the hood panel 59 and the front end portion 58c of the cowl top panel 58. Further, the cowl top panel 58 is provided with a

projection portion 58x that protrudes upward in order to prevent rainwater from entering inside the vehicle 50 through the gap 50h, or the like. A wiper 57 for scraping off water droplets adhering to the front window 54 is attached to an upper surface of the cowl top panel 58.

The airbag device 10 includes the airbag 30 mounted on a left side of the vehicle 50, an inflator 12 that discharges inflation gas to be supplied to the airbag 30, and a case 13 that accommodates the airbag 30 in a folded state. Further, the airbag device 10 includes the airbag 40 mounted on a right side of the vehicle 50, an inflator (not shown) that discharges inflation gas to be supplied to the airbag 40, and a case (not shown) that accommodates the airbag 40 in a folded state.

Here, the airbag 40, the inflator that supplies the inflation gas to the airbag 40, and the case that accommodates the airbag 40 have the same configuration as the airbag 30, the inflator 12, and the case 13, and are attached to the vehicle 50 by the same attachment configuration, and operate symmetrically. Therefore, hereinafter, the airbag 30, the inflator 12, and the case 13 will be described in detail, and the description of the airbag 40, the inflator that supplies the inflation gas to the airbag 40, and the case that accommodates the airbag 40 will be omitted as appropriate.

Further, the airbag device 10 includes an acceleration sensor 17 used for detecting a collision of the vehicle 50, an actuator (not shown) that lifts the rear end portion 59a of the hood panel 59 upward, the inflator 12 and an inflator (not shown) that supplies the inflation gas to the airbag 40 according to a detection result of the acceleration sensor 17, and a control device (not shown) that controls an operation of the actuator.

The acceleration sensor 17 is attached to a front bumper 53 of the vehicle 50, and detects an impact caused by a collision or the like of the vehicle 50 as acceleration. The control device (not shown) includes a CPU, a memory, and the like, and is attached to a predetermined position inside the vehicle 50. The control device is electrically connected to the inflator 12, the inflator (not shown) that supplies the inflation gas to the airbag 40, and the actuator (not shown), and transmits an operation signal to these members according to the detection result of the acceleration sensor 17.

The inflator 12 is a substantially columnar member disposed inside the airbag 30, and has, at a tip end portion thereof in the left-right direction, a gas discharge port (not shown) for discharging the inflation gas. The inflator 12 is operated when an operation signal is received from the control device (not shown) so as to generate the inflation gas, and discharges the inflation gas from the gas discharge port to supply the inflation gas into the airbag 30.

Further, the inflator 12 is attached to the inner panel 59x1 of the hood panel 59 together with the airbag 30 and the case 13 by a bolted clamp 18 made of metal. Specifically, the bolted clamp 18 includes an annular clamp portion 18a that can be reduced in diameter, and a bolt portion 18b that protrudes upward from an outer peripheral surface of the clamp portion 18a. The clamp portion 18a is wound around an outer periphery of the inflator 12. The bolt portion 18b is inserted into screw holes (not shown) formed in the airbag 30, the case 13, and the inner panel 59x1 in a state where the clamp portion 18a is wound around the inflator 12, and is fastened by a nut 19. By fastening the nut 19, the clamp portion 18a is reduced in diameter to hold the inflator 12, and the inflator 12, the airbag 30, and the case 13 are integrally fixed to the inner panel 59x1.

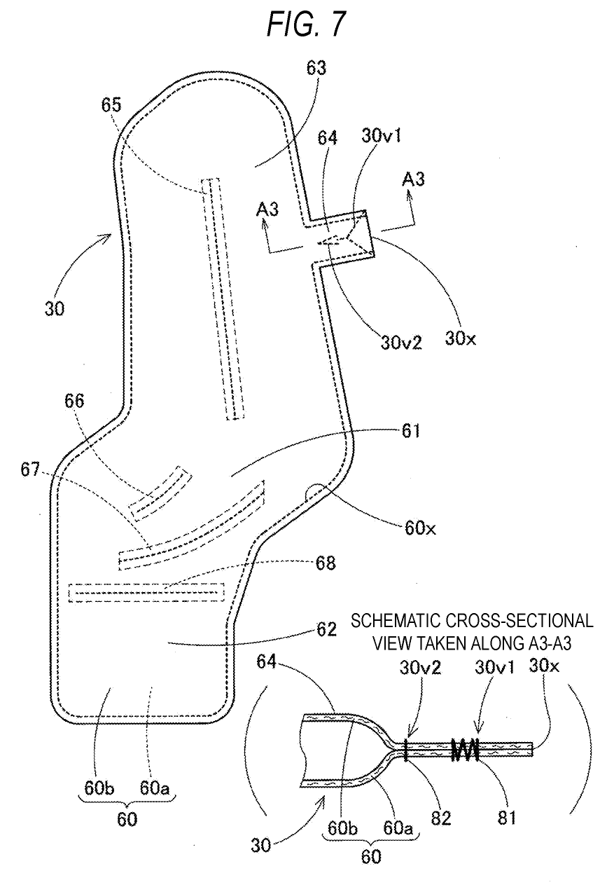

The airbag 30 is a bag-shaped member, is stored in the case 13 in a folded state before the inflation gas is supplied, and is delivered outside the vehicle 50 while being inflated and deployed from the folded state when the inflation gas is supplied to an inside. In the present embodiment, the airbag 30 is formed by an airbag panel 60 (see FIG. 7) that is a bag-shaped woven fabric made of polyester yarn.

The airbag 30 at a time of full inflation includes a cowl cover portion 30a that is disposed outside the vehicle 50 and is wide in the left-right direction to cover a periphery of a left end portion 58a of the cowl top panel 58 and a periphery of the front end portion 55a of the left front pillar 55 from above, and a connection portion 30b that is disposed inside the vehicle 50 and connects a portion accommodating the inflator 12 and the cowl cover portion 30a. The airbag 30 at the time of full inflation includes a pillar cover portion 30c that extends rearward from the cowl cover portion 30a and is wide in the front-rear direction to cover substantially an entire region of the left front pillar 55 other than the front end portion 55a from above, and a gas discharge portion 30d that extends leftward from a left end portion of the pillar cover portion 30c. A tip end portion of the gas discharge portion 30d is a gas discharge port 30x that is opened when a predetermined external pressure or more is applied to the airbag 30 after the airbag 30 is fully inflated, and discharges excess inflation gas inside the airbag 30 to the outside.

The case 13 is a substantially rectangular parallelepiped box-shaped member made of sheet metal and having a rear surface that is opened. As described above, the case 13 is fixed to the inner panel 59x1 of the hood panel 59 by the bolted clamp 18. In the present embodiment, although the case 13 having the rear surface opened in advance is used, in order to protect the airbag 30 from rainwater or the like, a configuration may be adopted in which when the airbag 30 is inflated, the airbag 30 is pressed and the rear surface is deformed or broken to form an opening, and the airbag 30 is delivered outside the case 13 from the opening.

Next, an operation of protecting the pedestrian M with the airbag device 10 will be described. First, when the vehicle 50 collides with the pedestrian M, the acceleration sensor 17 detects the collision as the acceleration. When the acceleration detected by the acceleration sensor 17 is equal to or greater than a predetermined value, the control device (not shown) determines that the vehicle 50 has collided, and transmits an operation signal to the inflator 12, the inflator (not shown) that supplies the inflation gas to the airbag 40, and the actuator (not shown).

Next, the actuator operated when receiving the operation signal lifts the rear end portion 59a of the hood panel 59 upward. Accordingly, the gap 50h between the hood panel 59 and the cowl top panel 58 of the vehicle 50 is widened. Further, the inflator 12 operated when receiving the operation signal supplies the inflation gas into the airbag 30. Similarly, the inflator (not shown) operated when receiving the operation signal supplies the inflation gas into the airbag 40.

Next, the airbag 30 started to be inflated by being supplied with the inflation gas is deployed from the folded state and delivered outside the vehicle 50 through the gap 50h. Thereafter, when the inflation gas is further supplied to the airbag 30, the airbag 30 is inflated to cover the periphery of the left end portion 58a of the cowl top panel 58 of the vehicle 50 and substantially the entire region of the left front pillar 55 from above, and the inflation is completed.

Similarly, the airbag 40 started to be inflated by being supplied with the inflation gas is deployed from the folded state and is delivered outside the vehicle 50 through the gap 50h. Next, when the inflation gas is further supplied to the airbag 40, the airbag 40 is inflated to cover a periphery of a right end portion 58b of the cowl top panel 58 of the vehicle 50 and substantially an entire region of the right front pillar 56 from above, and the inflation is completed. Thereafter, the pedestrian M who collides with the vehicle 50 to be flipped up and is about to collide violently with the cowl top panel 58, the left front pillar 55, or the right front pillar 56 is received and protected by the airbag 30 or the airbag 40.

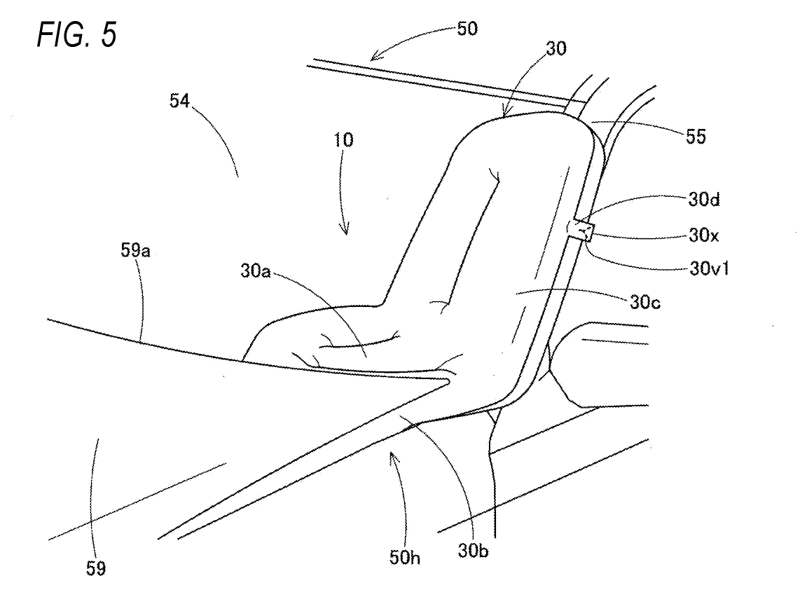

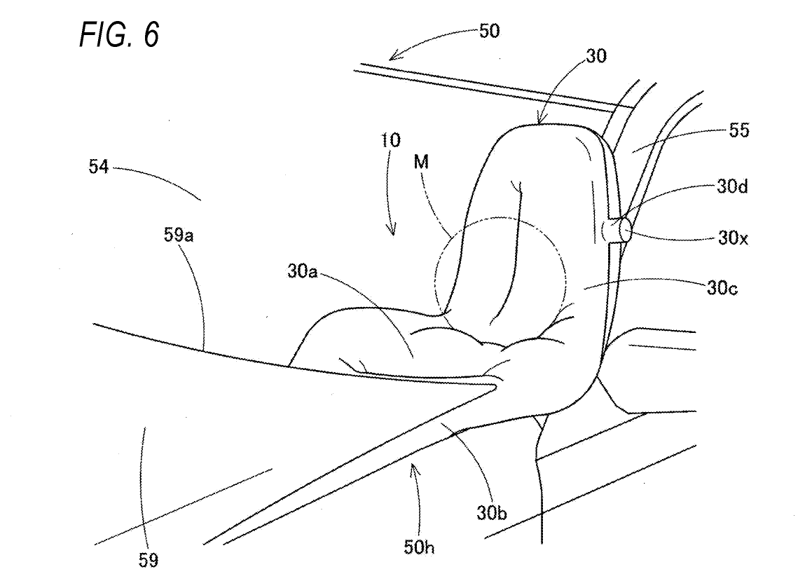

Further, as shown in FIG. 5, the gas discharge port 30x of the airbag 30 is sealed by sewing the airbag 30 at a first sewn portion 30v1 during a period until a predetermined external pressure or more is applied after the airbag 30 is fully inflated. As shown in FIG. 6, after the airbag 30 is full inflated, when a predetermined external pressure or more is applied to the airbag 30 while the airbag 30 is receiving the pedestrian M, the seam of the first sewn portion 30v1 is released to open the gas discharge port 30x.

Similarly, a gas discharge port 40x of the airbag 40 is sealed by sewing the airbag 40 at a first sewn portion 40v1 during a period until a predetermined external pressure or more is applied to the airbag 40 after the airbag 40 is fully inflated. After the airbag 40 is fully inflated, when a predetermined external pressure or more is applied to the airbag 40 while the airbag 40 is receiving the pedestrian M, the seam of the first sewn portion 40v1 is released to open the gas discharge port 40x.

In this way, in the airbags 30, 40, the internal pressure is maintained without discharging the inflation gas from the gas discharge ports 30x, 40x to the outside during a period until the pedestrian M is received, and after the pedestrian M is received, the gas discharge ports 30x, 40x are opened to discharge the inflation gas to reduce the internal pressure. Accordingly, the pedestrian M is received by the airbags 30, 40 in each of which a high reaction force is maintained, and is prevented from colliding violently with a ground or the like by being flipped up by the reaction force of the airbags 30, 40.

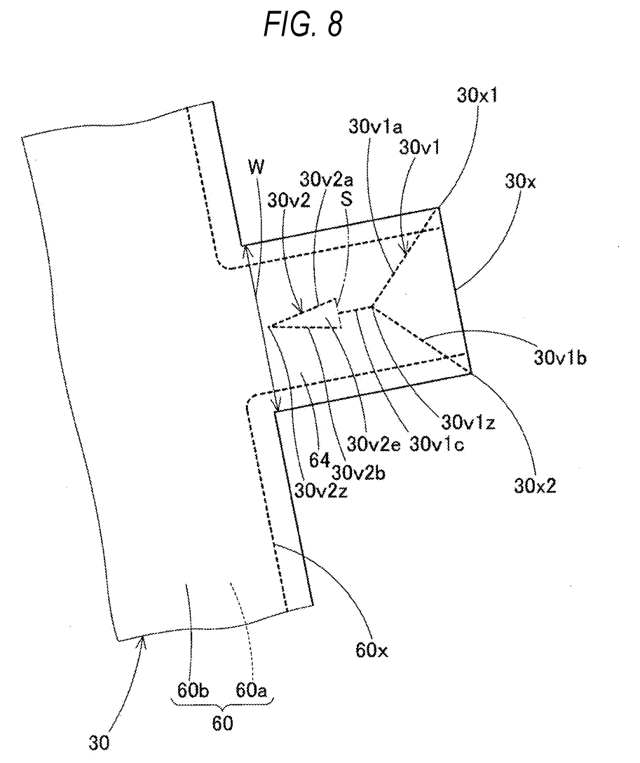

Next, a detailed configuration of the gas discharge port 30x of the airbag 30 will be described. FIG. 7 is a developed view in which the airbag 30 before inflation is deployed flat. FIG. 8 is an enlarged view of the periphery of the gas discharge port 30x of the airbag 30 shown in FIG. 7.

As shown in FIGS. 7 and 8, the airbag 30 is formed by an airbag panel 60 that is in a bag shape by sewing, at a sewn portion 60x, an outer peripheral edge of an inner panel 60a constituting a lower surface of the airbag 30 at the time of full inflation and an outer peripheral edge of an outer panel 60b constituting an upper surface of the airbag 30 at the time of full inflation. It can be said that the inner panel 60a constitutes a surface of the airbag 30 that faces the cowl top panel 58 and the left front pillar 55 at the time of full inflation. Further, it can be said that the outer panel 60b constitutes a surface of the airbag 30 that receives the pedestrian M at the time of full inflation.

The airbag panel 60 includes a cowl cover forming portion 61 that forms the cowl cover portion 30a when the airbag 30 is inflated, a connection forming portion 62 that forms the connection portion 30b, a pillar cover forming portion 63 that forms the pillar cover portion 30c, and a gas discharge forming portion 64 that forms the gas discharge portion 30d. Further, inside the airbag panel 60, four tethers 65, 66, 67 and 68 are provided in each of which one end portion and the other end portion are respectively sewn to the inner panel 60a and the outer panel 60b to regulate a thickness of the airbag 30 at the time of full inflation.

Further, in the airbag panel 60, the outer peripheral edge of the inner panel 60a and the outer peripheral edge of the outer panel 60b are partially unsewn together at the sewn portion 60x, and the unsewn portion serves as the gas discharge port 30x of the airbag 30. As described above, the gas discharge port 30x is sealed at the first sewn portion 30v1 (first sewn portion) during a period until a predetermined external pressure or more is applied to the airbag 30 after the airbag 30 is fully inflated. The first sewn portion 30v1 is a portion where the inner panel 60a and the outer panel 60b are sewn together to seal the gas discharge port 30x in a periphery of the gas discharge port 30x. After the airbag 30 is fully inflated, when a predetermined external pressure or more is applied to the airbag 30 while the airbag 30 is receiving the pedestrian M, the airbag 30 is deformed, the internal pressure increases, accordingly a sewing thread 81 of the first sewn portion 30v1 breaks, the thread comes off, and the seam of the first sewn portion 30v1 is released. Accordingly, the gas discharge port 30x is opened.

The first sewn portion 30v1 includes a first straight portion 30v1a(first straight portion) in which the inner panel 60a and the outer panel 60b are sewn together in a straight line, and a second straight portion 30v1b(second straight portion) which branches from the first straight portion 30v1a and in which the inner panel 60a and the outer panel 60b are sewn together in a straight line to extend in a direction intersecting an extending direction of the first straight portion 30v1a. Each of the first straight portion 30v1a and the second straight portion 30v1bhas a configuration in which stitches are zigzag but are sewn linearly as a whole.

The first straight portion 30v1a extends from a substantially central portion of the gas discharge forming portion 64 in a width direction W, that is, a substantially central portion of the gas discharge portion 30d of the airbag 30 in the width direction W at the time of full inflation, to a rear end portion 30x1 of the gas discharge port 30x. The second straight portion 30v1b extends from a substantially central portion of the gas discharge forming portion 64 in the width direction W, that is, a substantially central portion of the gas discharge portion 30d of the airbag 30 in the width direction W at the time of full inflation, to a front end portion 30x2 of the gas discharge port 30x. That is, a branch portion 30v1z between the first straight portion 30v1a and the second straight portion 30v1b of the first sewn portion 30v1 is disposed at the substantially central portion of the gas discharge portion 30d in the width direction W. The second straight portion 30v1b and the first straight portion 30v1a form a sewn portion having a substantially V shape. An opening of the substantially V shape faces the gas discharge port 30x.

The first sewn portion 30v1 includes a third straight portion 30v1c that branches from the first straight portion 30v1a and the second straight portion 30v1b at the branch portion 30v1z and in which the inner panel 60a and the outer panel 60b are sewn in a straight line to extend in a direction intersecting extending directions of the first straight portion 30v1a and the second straight portion 30v1b. The third straight portion 30v1c has a configuration in which stitches are zigzag but are sewn linearly as a whole. The third straight portion 30v1c extends from the branch portion 30v1z toward the pillar cover forming portion 63 in a direction orthogonal to the width direction W of the gas discharge portion 30d and a thickness direction of the airbag panel 60, and the third straight portion 30v1c, the first straight portion 30v1a and the second straight portion 30v1b form a sewn portion having a substantially Y shape. An opening of the substantially Y shape faces the gas discharge port 30x.

In the airbag panel 60, a second sewn portion 30v2 (second sewn portion) in which the inner panel 60a and the outer panel 60b are sewn together is formed in a periphery of the first sewn portion 30v1. In other words, in the airbag 30 before the inflation starts, the second sewn portion 30v2 in which the inner panel 60a and the outer panel 60b are sewn together is provided in the periphery of the first sewn portion 30v1. The periphery of the first sewn portion 30v1 refers to a range within 120 mm from the first sewn portion 30v1. That is, in a case where the first sewn portion 30v1 includes the first straight portion 30v1a, the second straight portion 30v1b, and the third straight portion 30v1c as in the present embodiment, at least a part of the second sewn portion 30v2 may be disposed in a range within 120 mm from any point of the first straight portion 30v1a, within 120 mm from any point of the second straight portion 30v1b, or within 120 mm from any point of the third straight portion 30v1c. In the present embodiment, since the third straight portion 30v1c is located on an inflator 12 side, the second sewn portion 30v2 is disposed in the periphery of the third straight portion 30v1cin order to reduce a stress applied to the first sewn portion 30v1 when the inflation gas flows in as much as possible.

The sewing thread 82 of the second sewn portion 30v2 breaks as the internal pressure of the airbag 30 increases due to the inflow of the inflation gas during a period from a time when the supply of the inflation gas to the airbag 30 by the inflator 12 is started until the time of full inflation of the airbag 30. Accordingly, the thread comes off, and the seam of the airbag 30 at the second sewn portion 30v2 is released. That is, at the second sewn portion 30v2, the seam is released as the internal pressure of the airbag 30 increases due to the inflow of the inflation gas during a period from the time when the supply of the inflation gas by the inflator 12 is started to the time of full inflation of the airbag 30. Here, the completion of inflation of the airbag 30 means that a shape of the airbag 30 is stabilized after the inflation is started, and no large deformation is observed.

The second sewn portion 30v2 includes a first straight portion 30v2a (first straight portion) in which the inner panel 60a and the outer panel 60b are sewn in a straight line, and a second straight portion 30v2b (second straight portion) which branches from the first straight portion 30v2a and in which the inner panel 60a and the outer panel 60b are sewn together in a straight line to extend in a direction intersecting an extending direction of the first straight portion 30v2a. Each of the first straight portion 30v2a and the second straight portion 30v2b has a configuration in which stitches are zigzag but are sewn linearly as a whole.

The first straight portion 30v2a extends obliquely rearward to the left from the substantially central portion of the gas discharge forming portion 64 in the width direction W, that is, the substantially central portion of the gas discharge portion 30d of the airbag 30 in the width direction W at the time of full inflation. The second straight portion 30v2b extends obliquely forward to the left from the substantially central portion of the gas discharge forming portion 64 in the width direction W, that is, the substantially central portion of the gas discharge portion 30d of the airbag 30 in the width direction W at the time of full inflation. That is, a branch portion 30v2z between the first straight portion 30v2a and the second straight portion 30v2b of the second sewn portion 30v2 is disposed at the substantially central portion of the gas discharge portion 30d in the width direction W. The second straight portion 30v2b and the first straight portion 30v2a form a sewn portion having a substantially V shape. An opening of the substantially V shape faces the gas discharge port 30x.

Further, a part of the third straight portion 30v1c ofthe first sewn portion 30v1 is disposed in a region 30v2e defined by the first straight portion 30v2a and the second straight portion 30v2b of the second sewn portion 30v2. Here, the region 30v2e refers to a region surrounded by the first straight portion 30v2a, the second straight portion 30v2b, and a virtual line S connecting endpoints of the first straight portion 30v2a and the second straight portion 30v2b when the branch portion 30v2z is set as a start point for each of the first straight portion 30v2a and the second straight portion 30v2b.

A sewing strength of the second sewn portion 30v2 is set to be weaker than a sewing strength of the first sewn portion 30v1. The sewing strengths can be set by, for example, making a pitch of the first sewn portion 30v1 smaller than a pitch of the second sewn portion 30v2, or making a strength of the sewing thread 81 of the first sewn portion 30v1 higher than a strength of the sewing thread 82 of the second sewn portion 30v2.

As described above, the airbag 30 of the present embodiment includes the first sewn portion 30v1 that seals the gas discharge port 30x, and is released from the sewn state as an external pressure is applied to the airbag 30 after the full inflation, to open the gas discharge port 30x. Accordingly, the following effects are provided.

That is, in a case of a configuration in which if a base fabric is separately provided in the airbag 30 to close the gas discharge port 30x, the base fabric is cut by an external pressure applied to the airbag 30 to open the gas discharge port 30x, it is necessary to provide an extra base fabric in the airbag 30 to close the gas discharge port 30x. Therefore, the airbag 30 in the folded state may increase in size, and a packaging property may deteriorate.

Meanwhile, in the present embodiment, the airbag 30 is provided with the first sewn portion 30v1 that seals the gas discharge port 30x, and the seam of the first sewn portion 30v1 is released as an external pressure is applied to the airbag 30 to open the gas discharge port 30x. Accordingly, the gas discharge port 30x can be opened at a timing when the pedestrian M or the like is received by the airbag 30 without separately providing a base fabric for closing the gas discharge port 30x. Therefore, according to the airbag device 10 of the present embodiment, the increase in size of the airbag 30 in a folded state can be prevented while providing the gas discharge port 30x in the airbag 30.

Further, the airbag 30 includes the second sewn portion 30v2 which is provided in the periphery of the first sewn portion 30v1 and at which the seam is released as the internal pressure of the airbag 30 increases due to the inflow of the inflation gas during a period from the time when the supply of the inflation gas is started to the time of full inflation of the airbag 30. Accordingly, the following effects are provided.

That is, when an gas output of the inflator 12 is large, there is a possibility that the sewing thread 81 of the first sewn portion 30v1 breaks due to a momentum during the deployment or the increase in the internal pressure of the airbag 30 during a period from the time when the supply of the inflation gas is started until the time of full inflation of the airbag 30, and the seam of the first sewn portion 30v1 is unintentionally released. In this case, since the gas discharge port 30x is opened before the pedestrian M is received, the internal pressure of the airbag 30 when receiving the pedestrian M is lower than expected.

Meanwhile, the second sewn portion 30v2 is provided in the periphery of the first sewn portion 30v1, as in the present embodiment, and thus the stress applied due to the momentum during the deployment or the increase in the internal pressure when the airbag 30 is inflated can be dispersed to the first sewn portion 30v1 and the second sewn portion 30v2. Therefore, the seam of the first sewn portion 30v1 can be prevented from being unintentionally released during a period from the time when the supply of the inflation gas to the airbag 30 is started until the time of full inflation of the airbag 30.

Further, the first sewn portion 30v1 includes the first straight portion 30v1a which is sewn in a straight line, and the second straight portion 30v1b which branches from the first straight portion 30v1a and is sewn in a straight line to extend in a direction intersecting the extending direction of the first straight portion 30v1a. Accordingly, the stress is easily concentrated on the branch portion 30v1z between the first straight portion 30v1a and the second straight portion 30v1b, and a starting point of the breakage of the sewing thread 81 is easily formed as compared with a configuration in which the first sewn portion 30v1 is formed by a single sewn portion that is sewn in a straight line. If this point is not taken into consideration, the first sewn portion 30v1 may have any other shape.

Further, the branch portion 30v1z between the first straight portion 30v1a and the second straight portion 30v1b is disposed at the substantially central portion of the gas discharge portion 30d of the airbag 30 in the width direction W. Accordingly, after the sewing thread 81 breaks at the branch portion 30v1z, a time until the seams at the first straight portion 30v1a and the second straight portion 30v1b is fully released is shortened, and the inflation gas can be quickly discharged through the gas discharge port 30x.

Further, the first straight portion 30v1a and the second straight portion 30v1b form the sewn portion having a substantially V shape, and the opening of the substantially V shape opening faces the gas discharge port 30x. Accordingly, since the branch portion 30v1z between the first straight portion 30v1a and the second straight portion 30v1b is easily disposed on a side close to the inflator 12, the stress is more easily concentrated on the branch portion 30v1z, and the starting point of the breakage of the sewing thread 81 is easily formed.

In the present embodiment, the second straight portion 30v1b branches from an end portion of the first straight portion 30v1a to form the sewn portion having a substantially V shape, but similar effects can be obtained in a configuration in which the second straight portion 30v1b branches from an intermediate portion of the first straight portion 30v1a to form the sewn portion having a substantially Y shape. Further, in the present embodiment, since the sewn portion having a substantially Y shape is formed by the first straight portion 30v1a, the second straight portion 30v1b, and the third straight portion 30v1c, the starting point of the breakage of the sewing thread 81 is the third straight portion 30v1c.

Further, the second sewn portion 30v2 includes the first straight portion 30v2a which is sewn in a straight line, and the second straight portion 30v2b which branches from the first straight portion 30v2a and is sewn in a straight line to extend in a direction intersecting the extending direction of the first straight portion 30v2a. Accordingly, the stress is likely to be concentrated on the branch portion 30v2z between the first straight portion 30v2a and the second straight portion 30v2b, and a starting point of the breakage of the sewing thread 82 is easily created as compared with a configuration in which the second sewn portion 30v2 is formed by a single sewn portion that is sewn in a straight line. If this point is not taken into consideration, the second sewn portion 30v2 may have any other shape.

In the second sewn portion 30v2, the second straight portion 30v2b and the first straight portion 30v2a form the sewn portion having a substantially V shape, and the opening of the substantially V shape faces the gas discharge port 30x. Accordingly, since the branch portion 30v2z between the first straight portion 30v2a and the second straight portion 30v2b is easily disposed on the side close to the inflator 12, the stress is more easily concentrated on the branch portion 30v2z, and the starting point of the breakage of the sewing thread 82 is easily formed. In the present embodiment, the second straight portion 30v2b branches from an end portion of the first straight portion 30v2a to form the sewn portion having a substantially V shape, but similar effects can be obtained in a configuration in which the second straight portion 30v2b branches from an intermediate portion of the first straight portion 30v2a to form the sewn portion having a substantially Y shape.

Further, a part of the third straight portion 30v1c of the first sewn portion 30v1 is disposed in the region 30v2e defined by the first straight portion 30v2a and the second straight portion 30v2b of the second sewn portion 30v2. Accordingly, since the first sewn portion 30v1 can be partially surrounded by the second sewn portion 30v2 during a period until the seam of the second sewn portion 30v2 is released, the stress applied to the first sewn portion 30v1 can be reduced, and the seam of the first sewn portion 30v1 can be effectively prevented from being unintentionally released. In particular, in the present embodiment, since the third straight portion 30v1c, which is the starting point of breakage of the sewing thread 81 of the first sewn portion 30v1, is partially surrounded by the second sewn portion 30v2, the seam of the first sewn portion 30v1 can be more effectively prevented from being unintentionally released.

The sewing strength of the second sewn portion 30v2 is set to be weaker than the sewing strength of the first sewn portion 30v1. Accordingly, the seam of the first sewn portion 30v1 can be prevented from being released before the seam of the second sewn portion 30v2 is released. Even if the first sewn portion 30v1 and the second sewn portion 30v2 have the same sewing strength, but since a distance between the inflator 12 and the second sewn portion 30v2 is shorter than a distance between the inflator 12 and the first sewn portion 30v1, the stress applied to the second sewn portion 30v2 is relatively large, and the seam of the second sewn portion 30v2 is released easiler than the first sewn portion 30v1. However, by setting the sewing strengths as described above, the seam of the first sewn portion 30v1 can be more stably prevented from being released before the seam of the second sewn portion 30v2 is released.

In the present embodiment, a configuration is illustrated in which the airbag 30 covers the periphery of the left end portion 58a of the cowl top panel 58 and substantially the entire region of the left front pillar 55 from above, and the airbag 40 covers the periphery of the right end portion 58b of the cowl top panel 58 and substantially the entire region of the right front pillar 56 from above. However, the present invention is not limited thereto, and shapes of the airbags 30, 40 may be changed as appropriate as long as the airbags 30, 40 are configured to at least partially cover the left front pillar 55 and the right front pillar 56 from above. Further, a connection portion that connects the airbag 30 and the airbag 40 may be provided above the cowl top panel 58 or the like, and the airbag 30 and the airbag 40 may be configured as one airbag.

What is claimed is:

1. An airbag device comprising:
an airbag configured to be folded and stored inside a vehicle, in which the airbag is delivered outside the vehicle while being inflated by being supplied with an inflation gas, and covers at least a part of a front pillar of the vehicle from above at a time of full inflation; and
an inflator configured to discharge the inflation gas to be supplied to the airbag, wherein
the airbag includes:
a gas discharge port that is an opening for discharging the inflation gas inside the airbag to an outside;
a first sewn portion which seals the gas discharge port, in which a seam of the first sewn portion is released, due to an external pressure applied to the airbag after the full inflation, to open the gas discharge port; and
a second sewn portion which is provided in a periphery of the first sewn portion, in which a seam of the second sewn portion is released as an internal pressure of the airbag increases due to an inflow of the inflation gas during a period from a time when a supply of the inflation gas by the inflator is started until the time of full inflation of the airbag.

2. The airbag device according to claim 1, wherein
the first sewn portion includes:
a first straight portion which is sewn in a straight line; and
a second straight portion which branches from the first straight portion and is sewn in a straight line to extend in a direction intersecting an extending direction of the first straight portion.

3. The airbag device according to claim 2, wherein
the first straight portion and the second straight portion form a sewn portion having a substantially V shape or a substantially Y shape, and the first straight portion and the second straight portion are disposed such that an opening of the substantially V shape or the substantially Y shape faces the gas discharge port.

4. The airbag device according to claim 1, wherein
the second sewn portion includes:
a first straight portion which is sewn in a straight line; and
a second straight portion which branches from the first straight portion and is sewn in a straight line to extend in a direction intersecting an extending direction of the first straight portion.

5. The airbag device according to claim 4, wherein
at least a part of the first sewn portion is disposed in a region defined by the first straight portion and the second straight portion of the second sewn portion.

6. The airbag device according to claim 4, wherein
the first straight portion of the second sewn portion and the second straight portion of the second sewn portion form a sewn portion having a substantially V shape or a substantially Y shape, and the first straight portion and the second straight portion of the second sewn portion are disposed such that an opening of the substantially V shape or the substantially Y shape faces the gas discharge port.

7. The airbag device according to claim 1, wherein
a sewing strength of the first sewn portion is higher than a sewing strength of the second sewn portion.
